(19) United States
(12) Patent Application Publication
(10) Pub. No.: US 2007/0113478 A1
(43) Pub. Date: May 24, 2007

(54) Emergency exit security gate

(76) Inventors: Fung Shan Chu, Markham (CA); Jian Wen Li, Etobicoke (CA); Jason Chun Sing Huen, Unionville (CA); Yu Ting Paul Chung, Markham (CA); Eddy H.D. Chung, Mississauga (CA)

Correspondence Address: Ralph A. Dowell of DOWELL & DOWELL P.C., 2111 Eisenhower Ave, Suite 406, Alexandria, VA, 22314, US

(21) Appl. No.: 11/283,731

(22) Filed: Nov. 22, 2005

(51) Int. Cl. E05C 7/02

(52) U.S. Cl. 49/67

(57) ABSTRACT

A security gate for use with an emergency or fire door mounted within an emergency exit wherein the gate is mountable in facing relationship to the door and is constructed to permit the door to be opened while the gate blocks or prevents unauthorized access through the exit to a protected area and wherein the gate includes a member for engaging a touch bar operating mechanism associated with the door to automatically and simultaneously open the door as the gate is opened outwardly from inside the protected area and wherein no modification to the door is necessary.

### BACKGROUND OF THE INVENTION

1. Field of the Invention

This invention is generally directed to heavy duty open mesh gates for use with conventional emergency exit fire and/or security doors used in businesses, commercial or retail establishments and residential environments and, more specifically, to such gates that are so structured that when locked in place relative to an emergency exit opening, permit an adjacent security or emergency exit door to be opened for purposes of increasing ventilation and light entrance with respect to an enclosed area but that provide adequate security to prevent unauthorized ingress through the gate into the enclosed area.

2. Brief Description of the Related Art

Metal security and fire doors are frequently used in buildings to prevent unauthorized passage though a doorway normally because of security and ingress control concerns. Because of safety concerns, such doors are provided with special heavy duty locking mechanisms that make tampering to obtain unauthorized access to an area extremely difficult. Normally, such doors are retained shut and locked unless personal are present to ensure authorized passage through the protected openings or unless an emergency within the protected area makes exit through the protected openings necessary.

In some instances it may be necessary to have individuals within a protected area make emergency passage through an emergency exit. Over the years, it has been determined that conventional door locks and knobs are unsatisfactory and potentially unsafe for use with emergency exit and/or fire doors, not only for mechanical reasons, but also due to the difficulty operating such devices during an emergency, such as when there is a panic situation or when visual recognition of door locks and/or knobs is difficult or impossible. To overcome such problems, many emergency exit doors are equipped with latch release mechanisms frequently termed or called “panic bars” or “touch bars”. Such bar-like release mechanisms extend over a substantial surface area and, when forced inwardly relative to the door, create effective leverage to cause heavy duty safety latches to be readily released. Such a conventional panic bar release is disclosed in U.S. Pat. No. 5,535,550 Yang.

Unfortunately, most such security and fire doors function as solid barriers thereby preventing passage of light and reducing air flow circulation relative to an enclosed area. There are many instances wherein it would be advantageous to be able to open a security or fire door in order to create a more compatible, comfortable or healthy environment by allowing light to enter an enclose area or to vent the area to the ambient surroundings. By way of example, it may be beneficial or become necessary to ventilate odors, smoke and the like from an otherwise enclosed area but still provide security to prevent unauthorized entrance into a protected area to protect people, goods or other items within the area.

### SUMMARY OF THE INVENTION

The present invention is directed to a unique security gate that is adapted to be easily mounted in facing relationship with substantially any type of security or fire door that utilizes a bar type operating mechanism, or “panic” or “touch” bar, for controlling the opening or release of one or more latches that normally retain the door in a closed and locked position. The security gate is constructed of steel frame components to which an expanded heavy duty metallic mesh material is welded or otherwise secured. The gate is preferably pivotally mounted to an outer steel frame that is secured to an interior wall or frame surrounding the perimeter of the exit opening normally blocked by the conventional emergency or fire door. The gate and outer frame cooperatively fit such that no large openings are created there between through which small animals can pass to obtain access through the opening into the protected area.

The gate carries a latch and locking assembly wherein the latch is normally engaged with a latch seat or housing in the outer frame such that the latch can not be tampered with from the outside thereof. The gate may be provided with a conventional type lock that can be opened from the outside by way or use of an appropriate and authorized key type device.

The gate is design to be locked with respect to the frame whenever the adjacent door is opened to thereby provide continued security with respect to a protected area but at the same time permit ventilation and passage of light through the exit opening. Should an emergency arise wherein the exit opening must be opened from the inside of the protected area, a release lever or similar equivalent structure, is engaged along the inside of the gate to release the latch associated with the locking assembly.

In those instances when both the emergency door and gate are in their closed and locked positions and a condition arises wherein immediate passage is required through the exit opening to permit people to egress there through, the present invention provides an engagement mechanism on an outer portion of the security gate that is designed to engage the panic or touch bar release mechanism associated with the conventional emergency or fire exit door. The engagement mechanism preferably includes a roller device that can engage with and roll along the panic or touch bar of the door lock such that the roller both depresses the bar to open the door while simultaneously traveling along the bar without any chance of binding or adverse friction being created between the roller and the panic bar. In this manner, both the gate and the fire or emergency door are simultaneously opened.

It is a primary object of the invention to provide a very sturdy open mesh gate that can be generally universally mounted in facing relationship with any conventional fire or emergency door having a panic or touch bar type latch or door lock release mechanism so that the operation of the latch control mechanism of the gate lock assembly will automatically unlock the latch of the door by operation of the panic bar associated therewith so that both the gate and the door are simultaneously unlocked and opened to permit emergency exit from a protected area.

It is a further object of the present invention to provide a security gate that can be installed relative to a conventional security door or fire door having a panic or touch bar type unlatching assembly wherein the security gate can be mounted relative to the door to secure the emergency exit when the door is opened but allow light and ventilation through the exit opening and wherein the door, when closed, is simultaneously opened when the security gate is opened during an emergency without any modifications or alterations being made to the door or it's locking and latch release mechanisms such that the integrity of the door and it's lock assembly is not effected or compromised.

It is another object of the invention to provide a security gate for a security or fire door wherein increased security is provided at a security exit when both the gate and the door are closed and locked but wherein the gate and door may be simultaneously opened in an emergency and wherein installation of the gate is cost effective as no alteration or changes in the installation of the conventional door are required.

### BRIEF DESCRIPTION OF THE DRAWINGS

A better understanding of the invention will be had with reference to the accompanying drawings wherein:

FIG. 1 is front elevation view of the security gate of the invention in a closed position with respect to a closed security or fire door;

FIG. 2 is a rear elevation view of the security gate shown in FIG. 1 with the security door in an open position;

FIG. 3 is a cross sectional view taken along line 3-3 of FIG. 1.

FIG. 4 is a view similar to FIG. 3 showing illustrating the manner in which the security gate engages the panic bar operating mechanism of the security door to simultaneously unlatch and open the gate and the door; and

FIG. 5 is an enlarged perspective view of the operating mechanism for unlatching the door lock as the security gate is being opened.

### DESCRIPTION OF THE PREFERRED EMBODIMENT

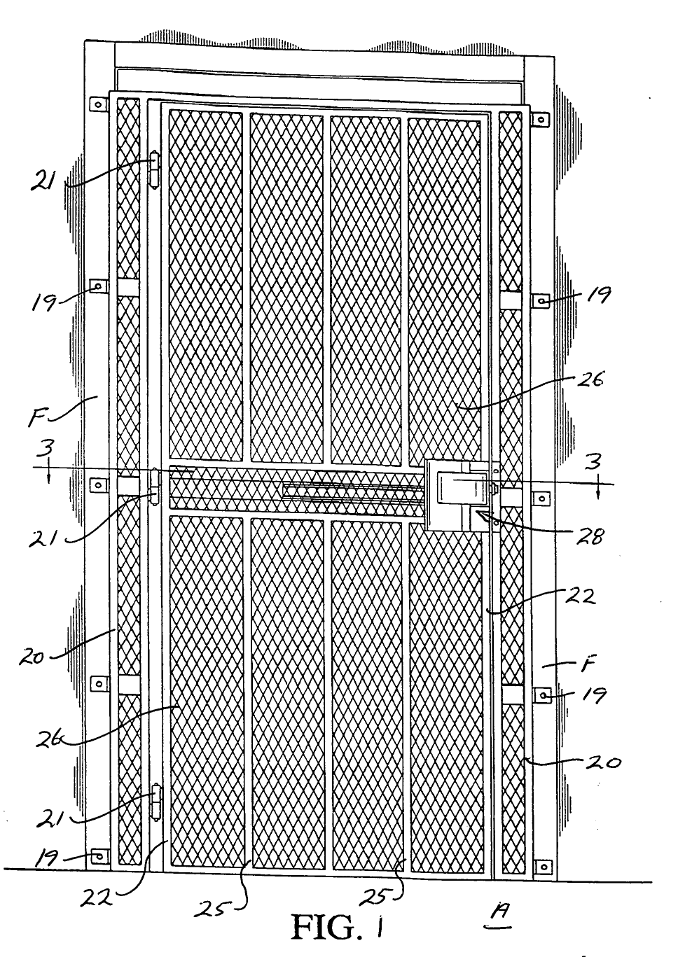

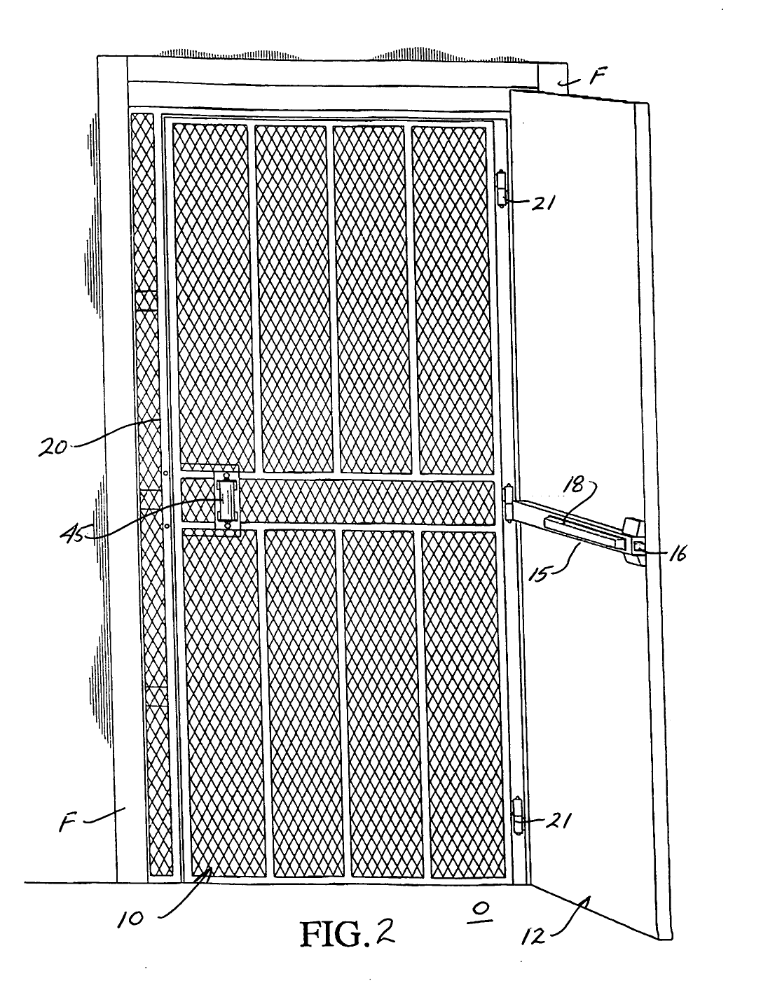

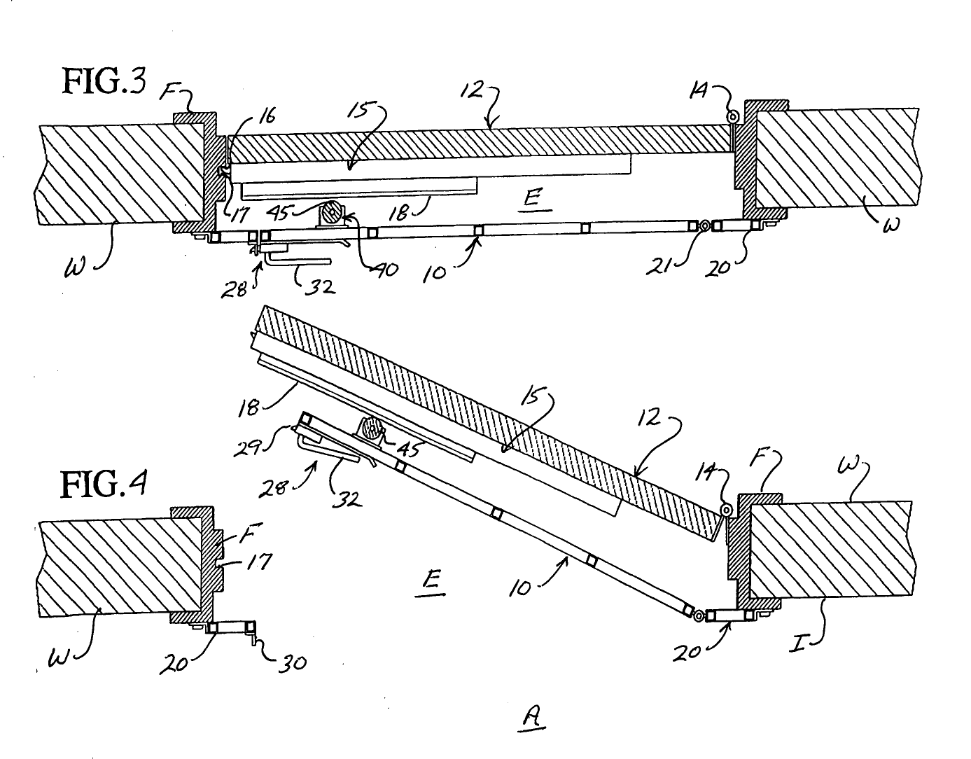

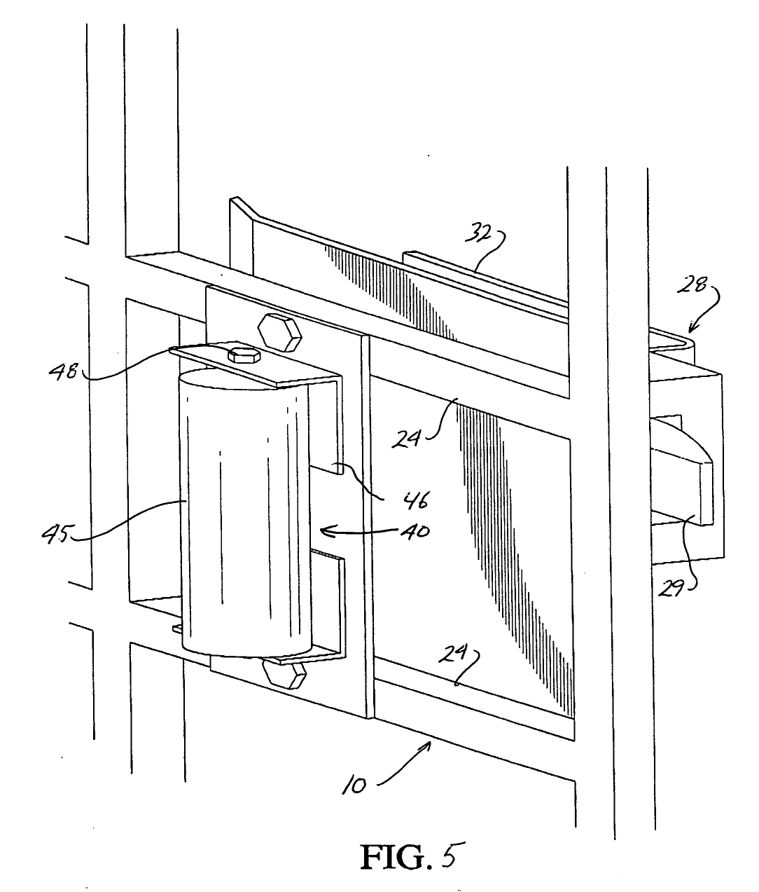

With continued reference to the drawing figures, a security gate 10 for use with a conventional security, emergency or fire door 12 is shown that permits the door to be selectively opened when the gate is locked such that a protected area interior of the door and gate remains secured. The door 12 is preferably constructed of at least a metal shell that contains a fireproof material. The door is shown as being mounted within an emergency exit “E” by way of conventional heavy duty hinges 14 that are secured to a door frame “F” in a conventional manner so that the door pivots between a closed position, as shown if FIGS. 1 and 3, to an open position, as shown in FIGS. 2 and 4, toward the outside “O” of a wall “W”. When in a closed position, the door 12 prevents unauthorized access to a protected area “A” along an inside “I” of the wall “W”.

The emergency door 12 includes a conventional lock assembly 15 that has at least one latch 16 that is normally seated within a latch plate housing 17 mounted within the door frame “F”. The latch 16 is withdrawn from engagement within the latch plate housing by pushing in on a touch or “panic” bar 18 associated with the lock assembly. The touch bar provides an elongated operating mechanism that is of conventional construction such that, when engaged, provides the necessary leverage and/or force to move the latch 16 to a withdrawn position to permit the emergency door to pivot to it's open position.

The emergency exit doors are used in commercial and industrial buildings as well as some residential buildings such as dormitories, condominiums, hotels and the like. The doors are designed to open to the outside so as to not interfere with free exit from the building during an emergency. The doors are normally closed and are not opened unless the exit is supervised in order to prevent unauthorized entry.

To permit the emergency door 12 to be selectively opened to allow light to enter into the enclosed area “A” and/or to permit ventilation through the exit opening “E”, while still prohibiting unauthorized access through exit, the security gate 10 is designed to be easily installed to the inner portion of the door frame “F” or to the inner portion “I” of the wall “W” adjacent the exit opening so as to be in direct facing relationship with the door 12. The gate is normally retained in a closed and locked position as is shown in FIG. 3.

In the embodiment shown, the gate 10 includes an outer mounting frame 20 formed of tubular steel that is anchored surrounding the exit opening by appropriated bolts or other fasteners 19, as shown in FIG. 1. The gate 10 is connected by hinges 21 to the mounting frame so as to be pivoted from a closed position shown in FIG. 3, to an open position as shown in FIG. 4.

The gate includes a peripheral frame member 22 also formed of tubular steel that is reinforced by horizontal cross frame members 24, two being shown in the embodiment, as well as vertical reinforcing members 25. A heavy duty or heavy gauge steel mesh 26 is welded or otherwise secured to the frame components in order to provide a barrier through which light and air can pass but wherein the spacing of the frame components and the mesh material prohibits small animals such as mice, rats and the like from passing there through. In this manner, the gate is designed to withstand tampering by an individual attempting to penetrate the gate in an unauthorized manner.

The gate carries a lock and latch assembly 28 that may be of any heavy duty and conventional type and may include a panic bar type operating assembly as discussed with respect to the door 12. However, in the embodiment shown, a latch 29 is withdrawn from a latch plate housing 30 welded or otherwise secured to the outer mounting frame 20 by operation of push handle mechanism 32.

In an emergency situation when the emergency door 12 is open and the gate 10 is locked and closed, the handle mechanism 32 is engaged to cause the latch to withdraw to permit the gate to pivot to its open position. The lock and latch assembly 28 may include a key device that permits authorized opening of the latch from the outside of the emergency exit.

When both the emergency door and the security gate are closed, the gate provides an increased measure of security to prevent unauthorized access to the protected area. However, in the event of an emergency, both the door and gate must be quickly and easily opened from the inside in order to permit a rapid and unobstructed exit from the protected area or space.

In this respect, the gate carries an engagement mechanism 40 for engaging the touch bar or “panic” bar 18 to thereby effectively unlatch the latch 16 from the latch plate housing 17 of the door 12 as the gate is being opened by the handle 32 being engaged to release the latch 29 from the latch housing 30. To prevent any binding between the gate and the touch bar of the door and to reduce frictional forces there between as the gate engages the door, the engagement mechanism is preferably formed including a roller 45. The roller is vertically mounted to a unshaped bracket 46 that is welded of otherwise secured to the outer surface 48 of the gate, as is shown in FIG. 5. The roller is mounted to the bracket 46 using a bolt of pin 48 that is retained by a nut (not shown) or that is welded in place to prevent tampering. Appropriate bearings may be provided to facilitate the free rotation of the roller.

In an emergency with both the door and gate closed, when a person pushes in on the handle 32 to open the gate 10, roller 45 immediately engages the touch bar 18 and rolls along the bar as the bar is pushed in to release the door 12 so that both the gate and the door are opened simultaneously.

One of the important features of the invention is that the gate may be installed without any need to move, adjust, rebuild or modify the emergency door. This allows the gate to be economically mounted for use with substantially all existing emergency doors or mounted or installed as a unit with newly installed emergency doors. Additionally, due to the rolling contact between the gate and the emergency door using the preferred embodiment of the invention described, the gate and door may be easily opened in an emergency without fear of jamming or interference of components of the gate and the door.

The foregoing description of the preferred embodiment of the invention has been presented to illustrate the principles of the invention and not to limit the invention to the particular embodiment described and illustrated. It is intended that the scope of the invention be defined by all of the embodiments encompassed within the following claims and their equivalents.

I claim:

1. An emergency security gate for use with an emergency door that normally closes an emergency exit from a protected area and wherein the door includes a touch bar for controlling a latch member to thereby unlock the door to permit the door to be opened relative to the emergency exit, the emergency security gate comprising, a gate including a frame portion and an open mesh portion permitting light and ventilation through said gate, means for pivotally mounting said gate relative to the emergency exit in facing relationship with the emergency door, a latch and lock assembly for normally retaining said gate in a closed position blocking the emergency exit, release means mounted on said gate for controlling said latch and lock assembly to permit said gate to be opened relative to said emergency exit, and an engaging member carried by said gate for engaging and urging the touch bar to a position to release the latch member of the door as said gate is being pivoted to the open position thereof such that said gate and the door are simultaneously opened.

2. The emergency security gate of claim 1 wherein said engaging member includes a roller, and means to rotatably mount said roller to said gate.

3. The emergency security gate of claim 2 including an outer mounting frame, and securing means for securing said outer mounting frame about the emergency exit.

4. The emergency security gate of claim 3 wherein said means for pivotally mounting said gate includes hinges for mounting said gate within said outer mounting frame.

5. The emergency security gate of claim 4 wherein said frame portion of said gate is formed of steel tubing to which said open mesh portion is securely mounted.

6. The emergency security gate of claim 5 wherein said release means includes an outwardly projecting push handle that is depressed toward said gate to thereby release a gate latch of said latch and lock assembly relative to a gate latch plate housing mounted to said outer mounting frame.

7. A combination emergency door and gate for an emergency exit of a structure, the combination including an emergency door having a door latch controlled by a touch bar operating member, means for pivotally mounting said door to be selectively opened and closed relative to the emergency exit, an emergency security gate, said emergency security gate including a gate including a frame portion and an open mesh portion permitting light and ventilation through said gate, means for pivotally mounting said gate relative to the emergency exit in facing relationship with said emergency door, a latch and lock assembly for normally retaining said gate in a closed position blocking the emergency exit, release means mounted on said gate for controlling said latch and lock assembly to permit said gate to be opened relative to said emergency exit, and an engaging member carried by said gate for engaging and urging said touch bar to a position to release said emergency door latch of said door as said gate is being pivoted to the open position thereof such that said gate and said door are simultaneously opened.

8. The combination emergency door and gate of claim 7 wherein said engaging member includes a roller, and means to rotatably mount said roller to said gate.

9. The combination emergency door and gate of claim 8 including an outer gate mounting frame, and securing means for securing said outer gate mounting frame about the emergency exit.

10. The combination emergency door and gate of claim 9 wherein said means for pivotally mounting said gate includes hinges for mounting said gate within said outer mounting frame.
